(19) United States
(12) Patent Application Publication
(10) Pub. No.: US 2022/0109336 A1
(43) Pub. Date: Apr. 7, 2022

(54) MAGNET MATERIAL, PERMANENT MAGNET, ROTARY ELECTRIC MACHINE AND VEHICLE, AND MANUFACTURING METHOD OF MAGNET MATERIAL AND PERMANENT MAGNET

(71) Applicant: KABUSHIKI KAISHA TOSHIBA, Tokyo (JP)

(72) Inventors: Masaya Hagiwara, Yokohama Kanagawa (JP); Shinya Sakurada, Saitama Saitama (JP)

(21) Appl. No.: 17/412,321

(22) Filed: Aug. 26, 2021

(30) Foreign Application Priority Data
Oct. 2, 2020 (JP) 2020-167842

(51) Int. Cl. H02K 1/17; H01F 1/057

(52) U.S. Cl. CPC H02K 1/17; H02K 1/223; H01F 1/0577

(57) ABSTRACT

A magnet material is represented by a formula: RₓD_{y}BeₛBₜM_{100-x-y-t} (R is at least one element selected from a group consisting of rare-earth elements, D is at least one element selected from a group consisting of Nb, Ti, Zr, Ta, and Hf, and M is at least one element selected from a group consisting of Fe and Co, and when a total number of elements obtained by adding R, D, B, and M is set to 100, x is a number satisfying 4.0<x≤11.0, y is a number satisfying 0≤y≤7.5, s is a number satisfying 0<s 1.0, and t is a number satisfying 0≤t<12), and includes a main phase having at least one crystal phase selected from a group consisting of a ThMn₁₂ type crystal phase and a TbCu₇ type crystal phase.

### CROSSREFERENCE TO RELATED APPLICATIONS

This application is based upon and claims the benefit of priority from Japanese Application (Japanese Patent Application No. 2020-167842), filed on Oct. 2, 2020; the entire contents of which are incorporated herein by reference.

### FIELD

Embodiments described herein generally relate to a magnet material, permanent magnets, a rotary electric machine and a vehicle, and manufacturing methods of the magnet material and the permanent magnets.

### BACKGROUND

Permanent magnets are used for products in a wide field including, for example, rotary electric machines such as a motor and a generator, electrical apparatuses such as a speaker and a measuring device, and vehicles such as an automobile and a railroad vehicle. In recent years, reduction in size and higher efficiency of the above-described products have been demanded, and high-performance permanent magnets having high magnetization and high coercive force have been desired.

As examples of the high-performance permanent magnets, there can be cited rare-earth magnets such as Sm—Co based magnets and Nd—Fe—B based magnets, for example. In these magnets, Fe and Co contribute to increase in saturation magnetization. Further, these magnets contain rare-earth elements such as Nd and Sm, which bring about a large magnetic anisotropy which is derived from a behavior of 4f electrons of the rare-earth elements in a crystal field. Consequently, it is possible to obtain a large coercive force.

A problem to be solved by the present invention is to provide a magnet material which increases a maximum magnetic energy product and coercive force of the magnet material, a permanent magnet, a rotary electric machine and a vehicle, and manufacturing methods of the magnet material and the permanent magnet.

### BRIEF DESCRIPTION OF THE DRAWINGS

FIG. 1 is a view illustrating an example of a permanent magnet motor according to an embodiment.

FIG. 2 is a view illustrating an example of a variable magnetic flux motor according to the embodiment.

FIG. 3 is a view illustrating an example of a generator according to the embodiment.

FIG. 4 is a schematic view illustrating a configuration example of a railway vehicle according to the embodiment.

FIG. 5 is a schematic view illustrating a configuration example of an automobile according to the embodiment.

FIG. 6 is a graph illustrating a relationship between a maximum magnetic energy product and a coercive force regarding examples and comparative examples presented in Table 1.

### DETAILED DESCRIPTION

A magnet material of an embodiment is represented by a composition formula: RₓD_{y}BeₛBₜM_{100-x-y-t} (R is at least one element selected from a group consisting of rare-earth elements, D is at least one element selected from a group consisting of Nb, Ti, Zr, Ta, and Hf, and M is at least one element selected from a group consisting of Fe and Co, and when a total number of elements obtained by adding R, D, B, and M is set to 100, x is a number satisfying 4.0<x≤11.0, y is a number satisfying 0≤y≤7.5, s is a number satisfying 0<s 1.0, and t is a number satisfying 0≤t<12), and includes a main phase having at least one crystal phase selected from a group consisting of a ThMn₁₂ type crystal phase and a TbCu₇ type crystal phase.

Hereinafter, embodiments will be described with reference to the drawings. Note that the drawings are schematic, and for example, a relation between a thickness and a plane dimension, a ratio of thicknesses of the respective layers, and the like are sometimes different from actual ones. Further, in the embodiments, substantially the same components are denoted by the same reference signs, and descriptions thereof are omitted.

### First Embodiment

A magnet material of an embodiment contains R (rare-earth element), M (M is at least one element selected from a group consisting of Fe and Co), D (D is at least one element selected from a group consisting of Nb, Ti, Zr, Ta, and Hf), Be, and B. The above-described magnet material includes a metal structure having a crystal phase containing high-concentration M as a main phase. Saturation magnetization can be improved by increasing an M concentration in the main phase. The main phase is a phase having the highest volume occupancy ratio in respective crystal phase and amorphous phase in the magnet material. The above-described magnet material may include a sub phase. The sub phase is, for example, a grain boundary phase present between crystal grains in the main phase, a microcrystalline phase, an impurity phase, or the like. As the crystal phase containing high-concentration M, there can be cited, for example, a ThMn₁₂ type crystal phase or a TbCu₇ type crystal phase.

In addition to R and M, amorphous forming ability can be increased to increase coercive force by adding D and B. As one of uses for the above-described magnet material, there are a bond magnet and a motor using it. In recent years, demands for reduction in size and speed-up of a motor are increasing, along with which a request for improvement in heat resistance of the magnet is increasing. An improvement in coercive force is necessary for the improvement in heat resistance.

In a magnet material having large magnetic anisotropy, as one of effective methods for exhibiting the coercive force, there is a method of making crystal grains in the magnet material fine. Accordingly, the main phase preferably has a microcrystal. The microcrystal is formed by, for example, producing an amorphous ribbon using a liquid quenching method, and thereafter subjecting it to appropriate heat treatment to perform precipitation and growth of the crystal grains.

Making the main phase having high magnetic anisotropy fine makes individual crystal grains likely to be in a single-domain state, which suppresses occurrence of an inverse domain and propagation of a magnetic domain wall to exhibit high coercive force. Because the coercive force is decreased both when a crystal grain diameter is too fine and when it is too coarse, an average crystal grain diameter of the main phase is preferably not less than 0.1 nm nor more than 100 nm, further preferably not less than 0.5 nm nor more than 80 nm, further preferably not less than 1 nm nor more than 60 nm, and further preferably not less than 3 nm nor more than 50 nm. In addition, narrowing a grain diameter distribution of the main phase enables an improvement in squareness ratio.

A non-magnetic or weak magnetic grain boundary phase may be formed as the grain boundary phase. This causes magnetic coupling between the crystal grains to be cut, which enhances an effect of suppressing the occurrence of the inverse domain and the propagation of the magnetic domain wall, resulting in enabling the improvement in coercive force.

[A] Composition Formula

In order to increase a maximum magnetic energy product and the coercive force, it is necessary to control an addition amount of each of R, M, D, Be, and B. The magnet material of the embodiment is represented by, for example, a composition formula: RₓD_{y}BeₛBₜM_{100-x-y-t}.

In the above-described composition formula, a value x, a value y, a value s, and a value t satisfy the following formulas when the total number of the elements obtained by adding R, D, B, and M is set to 100.

4.0<x≤11.0,

0≤y≤7.5,

0<s<1.0,

0≤t<12

Other than the above, the magnet material of the embodiment includes the main phase having at least one crystal phase selected from a group consisting of the ThMn₁₂ type crystal phase and the TbCu₇ type crystal phase. Note that the magnet material may contain inevitable impurities.

Hereinafter, the elements constituting the magnet material of this embodiment will be described in sequence.

[A-1] R R is a rare-earth element, and is an element capable of providing large magnetic anisotropy for the magnet material, and imparting the high coercive force to a permanent magnet. R is, concretely, at least one element selected from a group consisting of yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu).

In particular, as R, Sm is preferably used. For example, when a plurality of elements including Sm are used as R, the element making up 50 atom % or more of the total of R is preferably Sm. This makes it possible to increase performance, for example, the coercive force of the magnet material.

In the above-described composition formula, the value x indicating an addition amount of R is preferably a number satisfying, for example, 4.0<x≤11.0. Both when the value x is too small and when it is too large, a hetero-phase is precipitated to decrease the coercive force. It is more preferable that the value x is a number satisfying 6.2<x≤8, further a number satisfying 6.3≤x≤7.7, further a number satisfying 6.4≤x≤7.5, and further a number satisfying 6.5≤x≤7.4.

[A-2] D

D is at least one element selected from a group consisting of niobium (Nb), titanium (Ti), zirconium (Zr), tantalum (Ta), and hafnium (Hf), and is an element effective in stabilization of the crystal phase containing high-concentration M. Further, it is an element effective in promoting the amorphization.

In the above-described composition formula, the value y indicating an addition amount of D is preferably a number satisfying, for example, 0≤y≤7.5. When the addition amount of D is small, stability of the main phase is decreased, which makes the high coercive force unlikely to be obtained for the reason why, for example, the main phase is easily decomposed into an α-Fe phase and an R₂Fe₁₄B phase, or the like. When the addition amount of D is large, a proportion of a non-magnetic element in the magnet material is increased, which decreases the saturation magnetization. It is preferable that the value y is a number satisfying 0.2≤y≤6.5, further a number satisfying 0.5≤y≤5.0, further a number satisfying 1.0≤y≤3.0, further a number satisfying 0.5≤y≤5.0, and further a number satisfying 1.5≥y≤2.0.

As D, Nb is particularly preferably used. For example, when a plurality of elements including Nb are used as D, the element making up 50 atom % or more of the total of D is preferably Nb. This makes it possible to increase the performance, for example, the coercive force of the magnet material.

[A-3] M

M is at least one element selected from a group consisting of Fe and Co, and is an element responsible for high saturation magnetization of the magnet material.

In comparing Fe and Co, Fe causes higher magnetization, so that 50 atom % or more of the total of M is preferably Fe. Including Co in M causes the Curie temperature of the magnet material to rise, resulting in that a reduction in the saturation magnetization in a high-temperature region can be suppressed. Further, adding a small amount of Co allows the saturation magnetization to be further increased than a case where Fe is solely used. On the other hand, increasing a Co ratio causes a reduction in the anisotropic magnetic field. Moreover, a too high Co ratio also causes the reduction in the saturation magnetization. For this reason, by appropriately controlling the ratio between Fe and Co, it is possible to simultaneously achieve high saturation magnetization, high anisotropic magnetic field, and high Curie temperature.

When M in the composition formula is represented as (Fe_{1-y}Co_{y}), a preferable value of y is 0.01≤y<0.7, and the value y is more preferably 0.01≤y<0.5, and further preferably 0.01≤y<0.3.

In the composition formula, M may be at least one element selected from a group consisting of Ni, Cu, V, Cr, Mn, Al, Si, Ga, Ta, W, Ti, and Mo other than Fe and Co. At this time, an element making up 20 atom % or less of the total of M is preferably at least one element selected from the group consisting of Ni, Cu, V, Cr, Mn, Al, Si, Ga, Ta, W, Ti, and Mo. The above-described elements contribute to, for example, growth of crystal grains constituting the main phase.

[A-4] B

Boron (B) is an element effective in promoting the amorphization. By appropriately controlling an addition amount of B, it is possible to obtain an amorphous ribbon by such a method in which industrial productivity is high as a single-roll quenching method.

In the above-described composition formula, the value t indicating the addition amount of B is preferably a number satisfying, for example, 0≤t<12. When the addition amount of B is too large, a hetero-phase such as an R₂Fe₁₄B phase is likely to be formed, which decreases the coercive force. The amorphization is possible even though B is not substantially contained, but in a case of using a single-roll method, it is necessary to increase a roll peripheral speed to increase a cooling rate, which decreases the industrial productivity. The value t is more preferably a number satisfying 0.5≤t≤11, further preferably a number satisfying 1≤t≤10.8, and further preferably a number satisfying 2≤t≤10.5.

[A-5] Be

Beryllium (Be) is an element effective in promoting the amorphization. For example, when the amorphous ribbon is produced by the single-roll quenching method, it is possible to enhance wettability between a chill roll and an alloy molten metal. That causes a homogeneous amorphous ribbon to be obtained, which also makes a microcrystal after heat treatment homogeneous, thus resulting in that both a high maximum magnetic energy product and the high coercive force can be achieved. When low wettability between the chill roll and the alloy molten metal prevents the homogeneous amorphous ribbon from being obtained, a distribution of the coercive force or residual magnetization occurs in the ribbon after the heat treatment, which equalizes properties when, for example, the bond magnet is produced, thus making it difficult to achieve both the high maximum magnetic energy product and the high coercive force. Because it is industrially difficult to produce the bond magnet by selectively collecting only a portion where the properties in the ribbon are high, the ribbon having homogeneous properties is desirably produced. On one hand, a too large Be amount increases a precipitation amount of the hetero-phase, which decreases magnetic properties, particularly, the saturation magnetization and the coercive force.

In the above-described composition formula, the value s indicating an addition amount of Be is preferably a number satisfying, for example, 0<s<1.0. The value s more preferably satisfies 0.0001≤s≤0.2, and is further preferably a number satisfying 0.005≤s≤0.1, and further preferably a number satisfying 0.001≤s≤0.01.

[A-6] Y

In the above-described composition formula, as R, Y is preferably included.

Y is an element effective in stabilization of the crystal phase containing high-concentration M, for example, the ThMn₁₂ type crystal phase or the TbCu₇ type crystal phase. In the crystal phase containing high-concentration M, the higher the M concentration is made, the higher the saturation magnetization becomes, which enables an increase in the magnetic properties, but the higher M concentration makes a crystal structure unstable, which causes the decomposition of the main phase and the precipitation of an α-Fe or α-(Fe, Co) phase, thereby decreasing the coercive force. In contrast with this, including Y as R makes it possible to increase stability of the crystal phase containing high-concentration M, which allows the M concentration to be made higher. As a result, it is possible to achieve both the high coercive force and the high magnetization.

When the number of R is set to 1, a value u indicating an addition amount of Y preferably satisfies 0.01≤u≤0.5. When the value u is too small, an effect of stabilization is small, and when the value u is too large, the magnetic anisotropy is decreased, which decreases the coercive force. The value u is more preferably a number satisfying 0.02≤u≤0.4, and is further preferably 0.05≤u≤0.3.

[A-7] Value of z

Incidentally, in the composition formula, a value z defined by (100−x−y−t)/(x+y) is in proportion to an addition amount of M, and the larger the value z is, the higher magnetization is obtained. The value z is preferably a number satisfying 7.5≤z≤12. When the value z is less than 7.5, the M concentration is decreased, which decreases the magnetization. When the value z is larger than 12, the precipitation of the α-Fe or α-(Fe, Co) phase is not avoided, which decreases the coercive force. The value z is more preferably a number satisfying 8≤z≤12, and is further preferably 8.5≤z≤12, and is further preferably a number satisfying 9<z≤12, and further preferably a number satisfying 9.5≤z≤12.

[A-8] A

The magnet material of the embodiment may further contain A. A is at least one element selected from a group consisting of nitrogen (N), carbon (C), hydrogen (H), and phosphorus (P). A has a function of entering a crystal lattice to cause at least one of enlargement of the crystal lattice and change in electronic structure, for example. This makes it possible to change the Curie temperature, the magnetic anisotropy, and the saturation magnetization. A need not necessarily be added, except for inevitable impurities.

When A is contained, the magnet material of the embodiment is represented by, for example, a composition formula: RₓD_{y}BeₛBₜA_{z}M_{100-x-y-t-z}. At this time, the value z indicating an addition amount of A is a number satisfying 0≤z≤18 when the total number of the elements obtained by adding R, D, B, M, and A is set to 100. When the value z exceeds an upper limit value of the above-described formula, the crystal phase containing high-concentration M, for example, the ThMn₁₂ type crystal phase or the TbCu₇ type crystal phase becomes unstable, which decreases the coercive force.

The magnet material of the embodiment may have a form of a quenched alloy ribbon produced by a liquid quenching method (melt-spun method), or, for example, a powder form or the like using the quenched alloy ribbon as a raw material. An average thickness of the ribbon is preferably not less than 1 μm nor more than 100 μm. When the ribbon is too thin, a proportion of a surface deterioration layer is increased, which decreases the magnetic properties, for example, the magnetization. Further, when the ribbon is too thick, a distribution of a cooling rate is likely to occur in the ribbon, which decreases the coercive force. The average thickness of the ribbon is preferably not less than 10 μm nor more than 60 μm, further preferably not less than 15 μm nor more than 50 μm, and further preferably not less than 20 μm nor more than 40 μm.

[B] Property

[B-1] Specific Coercive Force

A specific coercive force of the magnet material of the embodiment is not less than 300 kA/m nor more than 2500 kA/m. In order to enhance heat resistance, it is more preferably not less than 500 kA/m nor more than 2500 kA/m, further preferably not less than 600 kA/m nor more than 2500 kA/m, further preferably not less than 610 kA/m nor more than 2500 kA/m, further preferably not less than 620 kA/m nor more than 2500 kA/m, and further preferably not less than 640 kA/m nor more than 2500 kA/m.

[B-2] Residual Magnetization

A residual magnetization of the magnet material of the embodiment is not less than 0.7 T nor more than 1.6 T. The higher residual magnetization is more effective in the reduction in size of the motor, or the like. The residual magnetization is preferably not less than 0.75 T nor more than 1.6 T, and further preferably higher than 0.8 T and equal to or lower than 1.6 T.

[C] Measurement Method

[C-1] Measurement Method of Composition

The composition of the magnet material is measured by, for example, inductively coupled plasma-atomic emission spectroscopy (ICP-AES), inductively coupled plasma-mass spectrometry (ICP-MS), scanning electron microscope-energy dispersive X-ray spectroscopy (SEM-EDX), transmission electron microscope-energy dispersive X-ray spectroscopy (TEM-EDX), scanning transmission electron microscope-energy dispersive X-ray spectroscopy (STEM-EDX), or the like. The volume ratios of the respective phases are determined in a comprehensive manner by using both of observation with an electron microscope or an optical microscope, and the X-ray diffraction or the like.

[C-2] Measurement of Average Grain Diameter of Main Phase

An average grain diameter of the main phase is found as follows. An arbitrary grain is selected with respect to main-phase crystal grains specified using the STEM-EDX on a cross section of the magnet material, and the longest straight line A whose both ends come in contact with other phases is drawn with respect to the selected grain. Next, a straight line B which is perpendicular to the straight line A and whose both ends come in contact with other phases is drawn at the midpoint of the straight line A. An average of lengths of the straight line A and straight line B is set as a diameter D of the phase. Ds of one or more arbitrary phases are found by the above-described process. The above-described Ds are each calculated from five fields of view per one sample, and an average of the respective Ds is defined as a diameter (D) of the phase. As the cross section of the magnet material, there is used a cross section at a substantially central portion of a surface having a maximum area of the sample.

[C-3] Average Thickness of Quenched Alloy Ribbon

An average thickness of the quenched alloy ribbon is found as follows, for example. With respect to a ribbon piece of 10 mm or longer, a thickness is measured using a micrometer. The thicknesses of ten or more ribbon pieces are measured to find an average value of values except a maximum value and a minimum value, thereby calculating the average thickness of the ribbon.

[C-4] Magnetic Property

The magnetic properties such as the coercive force and the magnetization of the magnet material are calculated using a vibrating sample magnetometer (VSM), for example.

[D] Manufacturing Method of Magnet Material

Next, an example of a manufacturing method of the magnet material of the embodiment will be described. First, an alloy containing predetermined elements required for the magnet material is manufactured. The alloy can be manufactured by using, for example, an arc melting method, a high-frequency melting method, a metal mold casting method, a mechanical alloying method, a mechanical grinding method, a gas atomizing method, a reduction diffusion method, or the like.

The above-described alloy is melted to be quenched. This makes the alloy amorphous. The melted alloy is cooled by using the liquid quenching method (melt-spun method), for example. In the liquid quenching method, the alloy molten metal is injected to a roll which rotates at a high speed. The roll may be either a single-roll type or a twin-roll type, and copper, a copper alloy, or the like is mainly used as a material thereof. The copper alloy is mainly beryllium copper, phosphor bronze, or the like. Beryllium copper is particularly preferably used. Using beryllium copper enhances wettability between the molten metal and the roll to obtain a homogeneous amorphous ribbon. Controlling an amount of the molten metal to be injected and a peripheral speed of the rotating roll makes it possible to control a cooling rate of the molten metal. A degree of the amorphization of the alloy can be controlled by the composition and the cooling rate. Further, in a case where an amorphous alloy has already been obtained by using the gas atomizing method or the like at the time of producing the above-described alloy, the quenching process need not be performed again.

Heat treatment is performed on the above-described amorphized alloy or alloy ribbon. This makes it possible to crystallize the main phase to form a metal structure including the main phase having the microcrystal. For example, heating is performed under an inert atmosphere such as in Ar or in a vacuum at a temperature of not less than 500° C. nor more than 1000° C. for not less than 1 minute nor more than 300 hours.

When the temperature is too low, crystallization and homogenization become insufficient to decrease the coercive force. Further, when the temperature is too high, the hetero-phase is formed by the decomposition of the main phase, or the like, which decreases the coercive force and squareness. A heating temperature is more preferably, for example, not less than 500° C. nor more than 900° C., further preferably not less than 520° C. nor more than 800° C., further preferably not less than 540° C. nor more than 700° C., and further preferably not less than 550° C. nor more than 650° C. When the heating time is too short, the crystallization and the homogenization become insufficient to decrease the coercive force.

When the heating time is too long, the hetero-phase is formed by the decomposition of the main phase, or the like, which decreases the coercive force and the squareness. A preferable heating time is not less than 5 minutes nor more than 200 hours, and the heating time is further preferably not less than 15 minutes nor more than 150 hours, further preferably not less than 30 minutes nor more than 120 hours, further preferably not less than 1 hour nor more than 120 hours, further preferably not less than 2 hours nor more than 100 hours, and further preferably not less than 3 hours nor more than 80 hours.

The crystallized alloy or ribbon is cooled by a method such as furnace cooling, water quenching, gas quenching, or in-oil quenching after the heating.

It is also possible to make A enter the above-described alloy. The alloy is preferably ground into a powder before the process of making A enter the alloy. When A is nitrogen, heating the alloy in an atmosphere of nitrogen gas, ammonia gas, or the like at about not less than 0.1 atmospheric pressure nor more than 100 atmospheric pressure, at a temperature of not less than 200° C. nor more than 700° C. for not less than 1 hour nor more than 100 hours makes it possible to nitride the alloy to make N enter the alloy. When A is carbon, heating the alloy in an atmosphere of C₂H₂, CH₄, C₃H₈, or CO gas or thermal decomposition gas of methanol at about not less than 0.1 atmospheric pressure nor more than 100 atmospheric pressure in a temperature range of not less than 300° C. nor more than 900° C. for not less than 1 hour nor more than 100 hours makes it possible to carbonize the alloy to make C enter the alloy. When A is hydrogen, heating the alloy in an atmosphere of hydrogen gas, ammonia gas, or the like at about 0.1 to 100 atmospheric pressure, in a temperature range of 200 to 700° C. for 1 to 100 hours makes it possible to hydrogenate the alloy to make H enter the alloy. When A is phosphorus, it is possible to phosphorize the alloy to make P enter the alloy.

The magnet material is manufactured through the above-described process. Further, magnet powder is manufactured by grinding the above-described alloy or ribbon. Moreover, permanent magnets such as a permanent magnet having a sintered compact and a bond magnet are manufactured using the above-described magnet material or magnet powder. One example of each of permanent magnet manufacturing processes is indicated.

[E] Manufacture of Permanent Magnet Having Sintered Compact

The above-described magnet material or magnet powder is pressure-sintered, thereby allowing the permanent magnet having the sintered compact to be formed. As a pressure-sintering method, after being pressurized with a press molding machine, a method of heating and sintering, a method of using a discharge plasma sintering method, a method of using a hot press, a method of using a hot working method, or the like is applicable. For example, the magnet material is ground using a milling machine such as a jet mill or a ball mill, and is subjected to a magnetic field orientating press at a pressure of about one ton in a magnetic field of about 1 to 2 T, thereby obtaining a molded body. The obtained molded body is heated and sintered in an inert gas atmosphere such as in Ar or in a vacuum, thereby producing the sintered compact. The permanent magnet having the sintered compact can be manufactured by appropriately giving heat treatment to the sintered compact in the inert atmosphere, or the like.

[F] Manufacture of Bond Magnet

Further, the above-described magnet material or magnet powder is mixed with a binder to be fixed with the binder, thereby allowing the bond magnet to be manufactured. As the binder, there can be used, for example, a thermosetting resin, a thermoplastic resin, a low-melting-point alloy, a rubber material, or the like. As a molding method, for example, a compression molding method or an injection molding method can be used.

The magnetic properties of the bond magnet, particularly, the residual magnetization and the maximum magnetic energy product can be increased by increasing a density of the bond magnet. Further, increasing the density causes pores of the bond magnet to decrease, thereby enabling an improvement in corrosion resistance.

An average length of the magnet material used for the bond magnet is preferably not less than 5 μm nor more than 1 mm. When it is less than 5 μm, flowing of the magnet material and the binder is unlikely to occur, which makes an improvement in density difficult. When it exceeds 1 mm, surface roughness of the bond magnet becomes large, which decreases dimensional accuracy. A lower limit of the average length is, for example, more preferably 20 μm or more, further preferably 50 μm or more, further preferably 100 μm or more, further preferably 150 μm or more, and further preferably 200 μm or more. An upper limit of the average length is, for example, more preferably 800 μm or less, and further preferably 500 μm or less.

The average length of the magnet material can be controlled by, for example, sieving. The average length may be controlled by adjusting grinding conditions such as a grinding time and a screen diameter of various milling machines such as a cutter mill and a hammer mill, and the like. The average length can be defined by finding long-side direction lengths of 50 or more pieces of powder from a SEM image to obtain an average value thereof, for example.

In order to increase the density of the bond magnet, a compression molding process is provided with a pressurizing step of applying a press pressure of 6×10² MPa or more, and a depressurizing step of subsequently lowering the press pressure to a pressure of 90% or less of the press pressure in the pressurizing step, which may be changed alternately to be repeated two or more times. Changing the pressurization and the depressurization causes the flowing of the binder and the material to progress in the course of homogenizing internal stress while being accompanied by release of local residual stress and plastic deformation of the material due to springback, resulting in allowing the pores of the bond magnet to decrease to achieve the increase in the density.

By applying rotational motion or reciprocating motion to a molding mold such as a pestle or a mortar at the time of compression molding, the press pressure may be applied. This causes force such as shear force to be applied, which allows the increase in the density to be achieved.

The binder of the bond magnet contains a resin such as, for example, an epoxy-based resin, a nylon-based resin, a polyamide-based resin, a polyimide-based resin, or a silicone-based resin. The resin may be a powdered resin, a liquid resin, or a mixture of resins in these forms, and particularly using the liquid resin makes the bond magnet likely to have a higher density. A viscosity of the liquid resin is preferably not less than 1 poise nor more than 500 poise.

The content of the binder is preferably not less than 0.5 mass % nor more than 5 mass %. When it exceeds 5 mass %, the magnetic properties are significantly decreased. When it is less than 0.5 mass %, a binding capacity falls short, which prevents sufficient strength from being obtained. The content of the binder is preferably not less than 1 mass % nor more than 4 mass %, and further preferably not less than 2 mass % nor more than 3 mass %.

The bond magnet may contain a coupling agent such as, for example, a titanium-based coupling agent or a silicon-based coupling agent. The coupling agent has an effect of improving dispersibility of powder, and is effective in improvement in magnet density. The magnet material is subjected to surface treatment by using a lubricant such as a fatty acid, fatty acid salts, amines, or amine acids, thereby enabling the improvement in the density.

### Second Embodiment

The permanent magnet including the magnet material of the first embodiment can be used for various motors or a generator. Further, it can also be used as a stationary magnet or a variable magnet of a variable magnetic flux motor or a variable magnetic flux generator. The various motors and generators are configured by using the permanent magnet of the first embodiment. When the permanent magnet of the first embodiment is applied to the variable magnetic flux motor, the techniques disclosed in Japanese Laid-open Patent Publication No. 2008-29148 and Japanese Laid-open Patent Publication No. 2008-43172 can be applied to the configuration of the variable magnetic flux motor and a drive system, for example.

Next, a motor and a generator including the above-described permanent magnet will be described with reference to the drawings.

[A] Permanent Magnet Motor

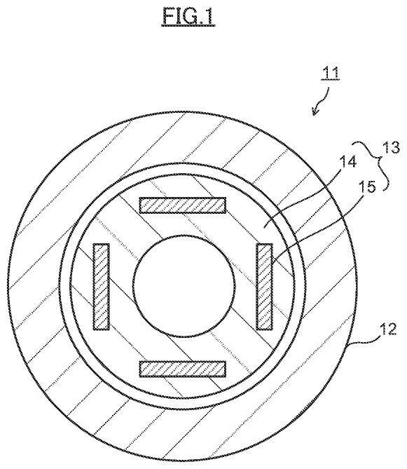

FIG. 1 is a view illustrating a permanent magnet motor. In a permanent magnet motor 11 illustrated in FIG. 1, a rotor 13 is disposed in a stator 12. In an iron core 14 of the rotor 13, permanent magnets 15 which are the permanent magnets of the first embodiment are disposed. Using the permanent magnets of the first embodiment makes it possible to achieve higher efficiency, reduction in size, lower costs, and the like of the permanent magnet motor 11 based on properties and the like of the respective permanent magnets. Further, the above-described permanent magnet can also be inserted into a flux barrier portion of a synchronous reluctance motor. This makes it possible to increase a power factor of the synchronous reluctance motor.

[B] Variable Magnetic Flux Motor

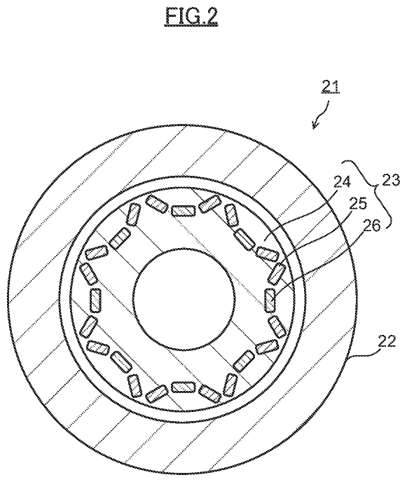

FIG. 2 is a view illustrating a variable magnetic flux motor. In a variable magnetic flux motor 21 illustrated in FIG. 2, a rotor 23 is disposed in a stator 22. In an iron core 24 of the rotor 23, the permanent magnets of the first embodiment are disposed as stationary magnets 25 and variable magnets 26. A magnetic flux density (flux quantum) of the variable magnet 26 is allowed to be variable. The variable magnet 26 is not affected by a Q-axis current but can be magnetized by a D-axis current because a magnetization direction thereof is perpendicular to a Q-axis direction. The rotor 23 is provided with a magnetization winding (not illustrated). There is made the structure in which passing an electric current from a magnetization circuit to this magnetization winding causes its magnetic field to act directly on the variable magnets 26.

According to the permanent magnet of the first embodiment, it is possible to obtain a coercive force suitable for the stationary magnet 25. When the permanent magnet of the first embodiment is applied to the variable magnet 26, it is sufficient that, for example, the coercive force is controlled in a range of not less than 100 kA/m nor more than 500 kA/m by changing manufacturing conditions. Note that in the variable magnetic flux motor 21 illustrated in FIG. 2, the permanent magnet of the first embodiment can be used for both the stationary magnet 25 and the variable magnet 26, and the permanent magnet of the first embodiment may be used for either of the magnets. Because the variable magnetic flux motor 21 is capable of outputting large torque with a small apparatus size, it is suitable for a motor of a hybrid vehicle, an electric vehicle, or the like required to have a high-output and compact motor.

[C] Generator

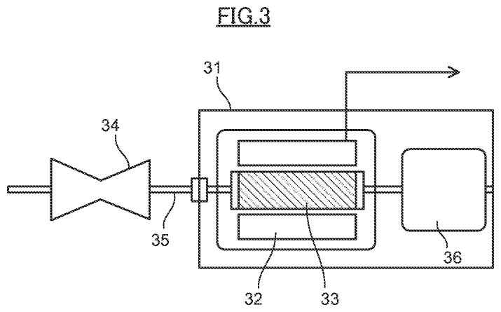

FIG. 3 illustrates a generator. A generator 31 illustrated in FIG. 3 includes a stator 32 using the above-described permanent magnet. A rotor 33 disposed inside the stator 32 is connected via a shaft 35 to a turbine 34 provided at one end of the generator 31. The turbine 34 is rotated by, for example, fluid supplied from the outside. Note that in place of the turbine 34 rotated by the fluid, the shaft 35 can also be rotated by transferring dynamic rotation such as regenerated energy of an automobile. Various publicly-known configurations can be employed for the stator 32 and the rotor 33.

The shaft 35 comes in contact with a commutator (not illustrated) disposed on the opposite side to the turbine 34 with respect to the rotor 33, so that an electromotive force generated by a rotation of the rotor 33 is boosted to a system voltage and is transmitted as an output from the generator 31 via an isolated phase bus and a main transformer (not illustrated). The generator 31 may be either of an ordinary generator and a variable magnetic flux generator. Note that the rotor 33 generates an electrostatic charge caused by static electricity from the turbine 34 and an axial current accompanying power generation. For this reason, the generator 31 includes a brush 36 for discharging the electrostatic charge of the rotor 33.

As described above, by applying the above-described permanent magnet to the generator, effects such as higher efficiency, reduction in size, and lower costs are obtained.

[D] Railway Vehicle

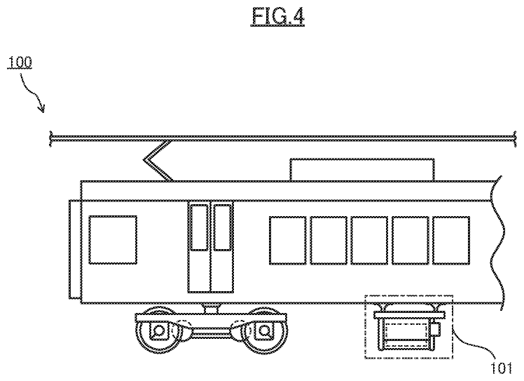

The above-described rotary electric machine may be mounted in, for example, a railway vehicle (one example of the vehicle) to be used for railway traffic. FIG. 4 is a view illustrating one example of a railway vehicle 100 including a rotary electric machine 101. As the rotary electric machine 101, any of the motors in FIGS. 1 and 2, the generator in FIG. 3, and the like described above can be used. When the above-described rotary electric machine is mounted as the rotary electric machine 101, the rotary electric machine 101 may be used as, for example, a motor which outputs driving force by using electric power supplied from an overhead wire or electric power supplied from a secondary battery mounted in the railway vehicle 100, or may be used as a generator which converts kinetic energy into electric power and supplies the electric power to various loads in the railway vehicle 100. Using such a high-efficient rotary electric machine as the rotary electric machine of the embodiment allows the railway vehicle to travel in an energy-saving manner.

[E] Automobile

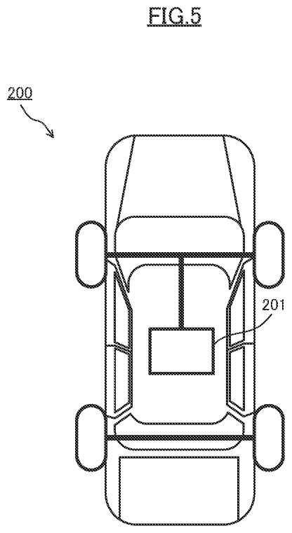

The above-described rotary electric machine may be mounted in an automobile (another example of the vehicle) such as a hybrid vehicle or an electric vehicle. FIG. 5 is a view illustrating one example of an automobile 200 including a rotary electric machine 201. As the rotary electric machine 201, any of the motors in FIGS. 1 and 2, the generator in FIG. 3, and the like described above can be used. When the above-described rotary electric machine is mounted as the rotary electric machine 201, the rotary electric machine 201 may be used as a motor which outputs driving force of the automobile 200 or a generator which converts kinetic energy at a time of travel of the automobile 200 into electric power. Further, the above-described rotary electric machine may be mounted in, for example, industrial equipment (industrial motor), an air-conditioning apparatus (air conditioner and water heater compressor motor), a wind power generator, or an elevator (hoist).

### EXAMPLES

### Examples 1-4

Appropriate amounts of raw materials were weighed to produce alloys by using an arc melting method. Next, the alloys were melted, and obtained molten metals were quenched by a single-roll method to produce quenched alloy ribbons. Beryllium copper was used for a roll. The above-described alloy ribbons were heated under an Ar atmosphere at a temperature of 650° C. for four hours to be gas-quenched. Compositions of magnet materials were evaluated using ICP-MS. The obtained magnet materials were ground so as to each have an average length of not less than 200 μm nor more than 500 μm. Each of ground powders, an epoxy-based resin, and a titanium-based coupling agent were weighed so as to have 97.0 mass %, 2.5 mass %, and 0.5 mass % respectively, and an appropriate amount of acetone was added to be mixed therewith. Thereafter, acetone was volatilized to produce mixed powders. After filling a mold with each of the obtained mixed powders, a pressurizing step of applying a pressure of 10.0×10² MPa to pressurize the filling materials and a depressurizing step of depressurizing them to atmospheric pressure thereafter were changed alternately and repeated five times to produce molded bodies. The obtained molded bodies were heat-treated at a temperature of 130° C. for one hour to produce bond magnets, and magnetic properties thereof were evaluated. Table 1 presents evaluation results of the composition, a coercive force, and a maximum magnetic energy product of each of the magnet materials. The coercive force and the maximum magnetic energy product were measured using a B-H tracer.

### Examples 5-9

Appropriate amounts of raw materials were weighed to produce alloys by using the are melting method. Next, the alloys were melted, and obtained molten metals were quenched by the single-roll method to produce quenched alloy ribbons. Beryllium copper was used for the roll. The above-described alloy ribbons were heated under the Ar atmosphere at a temperature of 630° C. for 12 hours to be gas-quenched. Compositions of magnet materials were evaluated using the ICP-MS. Bond magnets were produced using the obtained magnet materials by a similar method to that in Examples 1-4, and magnetic properties thereof were evaluated. Table 1 presents evaluation results of the composition, a coercive force, and a maximum magnetic energy product of each of the magnet materials. The coercive force and the maximum magnetic energy product were measured using the B-H tracer.

### Examples 10-19

Appropriate amounts of raw materials were weighed to produce alloys by using the are melting method. Next, the alloys were melted, and obtained molten metals were quenched by the single-roll method to produce quenched alloy ribbons. Beryllium copper was used for the roll. The above-described alloy ribbons were heated under the Ar atmosphere at a temperature of 600° C. for 30 hours to be gas-quenched. Compositions of magnet materials were evaluated using the ICP-MS. Bond magnets were produced using the obtained magnet materials by a similar method to that in Examples 1-4, and magnetic properties thereof were evaluated. Table 1 presents evaluation results of the composition, a coercive force, and a maximum magnetic energy product of each of the magnet materials. The coercive force and the maximum magnetic energy product were measured using the B-H tracer.

### Examples 20-22

Appropriate amounts of raw materials were weighed to produce alloys by using the are melting method. Next, the alloys were melted, and obtained molten metals were quenched by the single-roll method to produce quenched alloy ribbons. Beryllium copper was used for the roll. The above-described alloy ribbons were heated under the Ar atmosphere at a temperature of 800° C. for ten minutes to be gas-quenched. Compositions of magnet materials were evaluated using the ICP-MS. Bond magnets were produced using the obtained magnet materials by a similar method to that in Examples 1-4, and magnetic properties thereof were evaluated. Table 1 presents evaluation results of the composition, a coercive force, and a maximum magnetic energy product of each of the magnet materials. The coercive force and the maximum magnetic energy product were measured using the B-H tracer.

### Comparative Examples 1-4

Appropriate amounts of raw materials were weighed to produce alloys by using the are melting method. Next, the alloys were melted, and obtained molten metals were quenched by the single-roll method to produce quenched alloy ribbons. Copper was used for the roll. The above-described alloy ribbons were heated under the Ar atmosphere at a temperature of 600° C. for 30 hours to be gas-quenched. Compositions of magnet materials were evaluated using the ICP-MS. Bond magnets were produced using the obtained magnet materials by a similar method to that in Examples 1-4, and magnetic properties thereof were evaluated. Table 1 presents evaluation results of the composition, a coercive force, and a maximum magnetic energy product of each of the magnet materials. The coercive force and the maximum magnetic energy product were measured using the B-H tracer.

### Comparative Example 5

Appropriate amounts of raw materials were weighed to produce a magnet material by a similar method to that in Examples 20-22. A composition of the magnet material was evaluated using the ICP-MS. A bond magnet was produced using the obtained magnet material by a similar method to that in Examples 1-4, and magnetic properties thereof were evaluated. Table 1 presents evaluation results of the composition, a coercive force, and a maximum magnetic energy product of the magnet material. The coercive force and the maximum magnetic energy product were measured using the B-H tracer.

TABLE 1

| | | Bond magnet | |
|---|---|---|---|
| | | | Maximum |
| | | Specific | magnetic |
| | | coercive | energy |
| | Magnet material | force | product |
| | Composition | (kA/m) | (kJ/m³) |
| Ex- | Sm_{6.8}Nb_{1.8}Fe_{66.1}Co_{16.5}Be_{0.005}B_{8.8} | 610 | 83 |
| ample 1 | | | |
| Ex- | Sm_{7.2}Nb_{1.6}Fe_{65.8}Co_{16.4}Ti_{1.0}Be_{0.003}B_{8.0} | 580 | 81 |
| ample 2 | | | |
| Ex- | Sm_{6.5}Nb_{1.0}Zr_{1.0}Fe_{66.6}Co_{16.7}Be_{0.005}B_{8.2} | 585 | 86 |
| ample 3 | | | |
| Ex- | (Sm_{0.8}Y_{0.2})_{6.0}Nb_{1.5}Fe_{65.1}Co_{16.3}Ti_{2.5}Be_{0.008}B_{8.6} | 575 | 88 |
| ample 4 | | | |
| Ex- | Sm_{7.5}Nb_{1.2}Fe_{65.1}Co_{16.3}Si_{1.7}Be_{0.005}B_{8.2} | 600 | 80 |
| ample 5 | | | |
| Ex- | Sm_{7.2}Nb_{1.6}Fe_{64.8}Co_{16.2}Cu_{1.2}Si_{1.0}Be_{0.006}B_{8.0} | 615 | 80 |
| ample 6 | | | |
| Ex- | (Sm_{0.8}Y_{0.2})_{6.4}Nb_{2.0}Fe_{65.6}Co_{16.4}Si_{1.2}Be_{0.009}B_{8.4} | 595 | 87 |
| ample 7 | | | |
| Ex- | (Sm_{0.85}Y_{0.15})_{6.5}Nb_{1.9}Fe_{65.3}Co_{16.3}Ga_{1.5}Be_{0.007}B_{8.5} | 580 | 85 |
| ample 8 | | | |
| Ex- | (Sm_{0.8}Y_{0.2})_{6.6}Nb_{1.8}Fe_{64.7}Co_{16.2}Cu_{1.0}Ga_{1.0}Be_{0.004}B_{8.7} | 585 | 81 |
| ample 9 | | | |
| Ex- | Sm_{7.2}Nb_{1.6}Fe_{65.4}Co_{16.3}Si_{1.5}Be_{0.002}B_{8.0} | 605 | 80 |
| ample 10 | | | |
| Ex- | Sm_{6.6}Nb_{2.1}Fe_{65.4}Co_{16.4}Si_{1.0}Be_{0.003}B_{8.5} | 595 | 78 |
| ample 11 | | | |
| Ex- | Sm_{7.2}Nb_{1.6}Fe_{64.4}Co_{16.1}Ga_{1.0}Si_{1.5}Be_{0.005}B_{8.2} | 620 | 75 |
| ample 12 | | | |
| Ex- | Sm_{7.5}Nb_{1.0}Ta_{0.5}Fe_{66.2}Co_{16.5}Be_{0.0001}B_{8.3} | 610 | 81 |
| ample 13 | | | |
| Ex- | (Sm_{0.9}Y_{0.1})_{6.7}Nb_{1.9}Fe_{65.4}Co_{16.4}Si_{1.5}Be_{0.002}B_{8.1} | 590 | 88 |
| ample 14 | | | |
| Ex- | (Sm_{0.85}Y_{0.15})_{6.7}Nb_{1.5}Fe_{66.5}Co_{16.6}Be_{0.005}B_{8.7} | 580 | 90 |
| ample 15 | | | |
| Ex- | (Sm_{0.85}Y_{0.15})_{6.2}Nb_{2.0}Fe_{66.2}Co_{16.6}Be_{0.006}B_{9.0} | 600 | 89 |
| ample 16 | | | |
| Ex- | Sm_{6.6}Nb_{3.0}Fe_{64.9}Co_{16.1}Si_{1.3}Be_{0.005}B_{8.1} | 575 | 85 |
| ample 17 | | | |
| Ex- | Sm_{7.2}Nb_{1.6}Fe_{65.4}Co_{16.3}Si_{1.5}Be_{0.1}B_{8.0} | 580 | 70 |
| ample 18 | | | |
| Ex- | (Sm_{0.9}Y_{0.1})_{6.7}Nb_{1.9}Fe_{65.4}Co_{16.4}Si_{1.5}Be_{0.13}B_{8.1} | 570 | 75 |
| ample 19 | | | |
| Ex- | Sm_{7.7}Ti_{7.0}Fe_{66.2}Co_{18.6}Si_{0.5}Be_{0.005} | 590 | 60 |
| ample 20 | | | |
| Ex- | (Sm_{0.8}Y_{0.2})_{7.7}Ti_{7.0}Fe_{66.2}Co_{18.6}Si_{0.5}Be_{0.005} | 590 | 63 |
| ample 21 | | | |
| Ex- | Sm_{7.7}Nb_{7.0}Fe_{64.2}Co_{16.6}Si_{0.5}Be_{0.005}B_{4.0} | 600 | 59 |
| ample 22 | | | |
| Com- | Sm_{7.2}Nb_{1.6}Fe_{65.4}Co_{16.3}Si_{1.5}B_{8.0} | 560 | 70 |
| parative | | | |
| example 1 | | | |
| Com- | (Sm_{0.9}Y_{0.1})_{6.7}Nb_{1.9}Fe_{65.4}Co_{16.4}Si_{1.5}B_{8.1} | 550 | 80 |
| parative | | | |
| example 2 | | | |
| Com- | Sm_{6.6}Nb_{3.0}Fe_{64.9}Co_{16.1}Si_{1.3}B_{8.1} | 570 | 62 |
| parative | | | |
| example 3 | | | |
| Com- | Sm_{7.2}Nb_{1.6}Fe_{65.4}Co_{16.3}Si_{1.5}Be_{1.5}B_{8.0} | 150 | 35 |
| parative | | | |
| example 4 | | | |
| Com- | Sm_{7.7}Ti_{7.0}Fe_{66.2}Co_{18.6}Si_{0.5} | 560 | 55 |
| parative | | | |
| example 5 | | | |

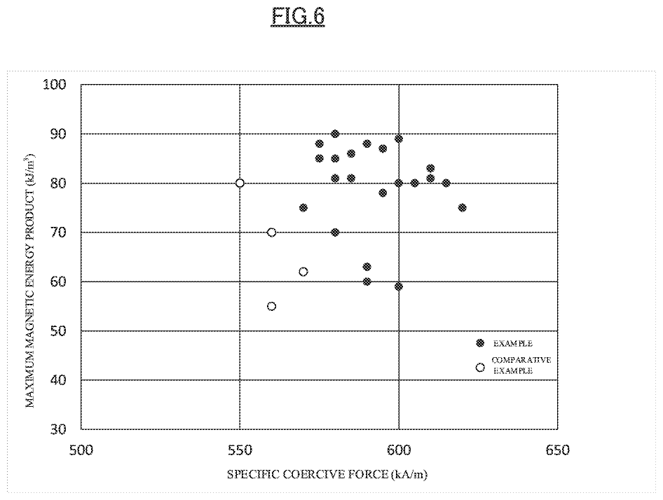

FIG. 6 is a graph illustrating a relationship between the maximum magnetic energy product and the coercive force regarding the examples and the comparative examples presented in Table 1. FIG. 6 illustrates the results except Comparative example 4 for convenience of illustration, but the result of Comparative example 4 is located on a lower left side in the figure as is seen from Table 1.

As illustrated in FIG. 6, a property group of Examples 1 to 22 is located on an upper right side in the figure further than a property group of Comparative examples 1 to 5, which makes it clear to achieve both a high maximum magnetic energy product and high coercive force.

Note that the above-described embodiments have been presented by way of example only, and are not intended to limit the scope of the inventions. Indeed the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 . . . permanent magnet motor, 13 . . . rotor, 14 . . . iron core, 15 . . . permanent magnet, 21 . . . variable magnetic flux motor, 23 . . . rotor, 24 . . . iron core, 25 . . . stationary magnet, 26 . . . variable magnet, 31 . . . generator, 32 . . . stator, 33 . . . rotor, 34 . . . turbine, 35 . . . shaft, 36 . . . brush, 100 . . . railway vehicle, 101 . . . rotary electric machine, 200 . . . automobile, 201 . . . rotary electric machine.

What is claimed is:

1. A magnet material represented by a composition formula: RₓD_{y}BeₛBₜM_{100-x-y-t} (R is at least one element selected from a group consisting of rare-earth elements, D is at least one element selected from a group consisting of Nb, Ti, Zr, Ta, and Hf, and M is at least one element selected from a group consisting of Fe and Co, and when a total number of elements obtained by adding R, D, B, and M is set to 100, x is a number satisfying 4.0<x≤11.0, y is a number satisfying 0≤y≤7.5, s is a number satisfying 0<s 1.0, and t is a number satisfying 0≤t<12), the magnet material comprising a main phase having at least one crystal phase selected from a group consisting of a ThMn₁₂ type crystal phase and a TbCu₇ type crystal phase.

2. The magnet material according to claim 1, wherein an element making up 50 atom % or more of a total of R is Sm.

3. The magnet material according to claim 1, wherein an element making up 50 atom % or more of a total of D is Nb.

4. The magnet material according to claim 1, wherein 50 atom % or more of a total of M is Fe.

5. The magnet material according to claim 1,
wherein, in the composition formula, M is at least one element selected from a group consisting of Ni, Cu, V, Cr, Mn, Al, Si, Ga, Ta, W, Ti, and Mo other than Fe and Co, and
wherein, an element making up 20 atom % or less of the total of M is at least one element selected from the group consisting of Ni, Cu, V, Cr, Mn, Al, Si, Ga, Ta, W, Ti, and Mo.

6. The magnet material according to claim 1,
wherein, as R, Y is included, and
wherein, when a number of R is set to 1, a number u of Y satisfies 0.01≤u≤0.5, and z defined by z=(100−x−y−t)/(x+y) is a number satisfying 7.5≤z≤12.

7. The magnet material according to claim 6, wherein z is a number satisfying 9<z≤12.

8. The magnet material according to claim 1,
wherein the composition formula includes A (A is at least one element selected from a group consisting of N, C, H, and P).

9. The magnet material according to claim 1, wherein a specific coercive force is 500 kA/m or more.

10. The magnet material according to claim 1, wherein a residual magnetization is 0.75 T or more.

11. The magnet material according to claim 1, wherein an average crystal grain diameter of the main phase is not less than 0.1 nm nor more than 100 nm.

12. A permanent magnet comprising:
the magnet material according to claim 1; and
a binder.

13. A permanent magnet comprising a sintered body of the magnet material according to claim 1.

14. A rotary electric machine comprising:
a stator; and
a rotor,
wherein the stator or the rotor comprises the permanent magnet according to claim 12.

15. The rotary electric machine according to claim 14, wherein the rotor is connected via a shaft to a turbine.

16. A vehicle comprising the rotary electric machine according to claim 15.

17. The vehicle according to claim 16, wherein the rotor is connected to a shaft, and rotation is transmitted to the shaft.

18. A manufacturing method of a magnet material,
the manufacturing method of the magnet material according to claim 1, comprising:
manufacturing an alloy containing elements represented by the composition formula;
cooling a molten metal of the alloy by injection to a roll, thereby amorphizing the alloy;
crystallizing the amorphized alloy by heat treatment; and
cooling the crystallized alloy.

19. The manufacturing method of the magnet material according to claim 18, wherein beryllium copper is used for a roll material.

20. A manufacturing method of a permanent magnet, comprising
mixing the magnet material according to claim 1 with a binder to be fixed therewith.

21. A manufacturing method of a permanent magnet, comprising
sintering the magnet material according to claim 1.
